(19) United States
(12) Patent Application Publication
(10) Pub. No.: US 2009/0225726 A1
(43) Pub. Date: Sep. 10, 2009

(54) MOBILE COMMUNICATION METHOD, MOBILE COMMUNICATION SYSTEM, AND RADIO BASE STATION

(75) Inventors: Akihito HANAKI, Yokohama-shi (JP); Akihiro FUJIWARA, Yokosuka-shi (JP); Takahiro HAYASHI, Yokosuka-shi (JP); Yoshikazu GOTO, Yokohama-shi (JP); Yukiko TAKAGI, Yokosuka-shi (JP); Junichiro KAWAMOTO, Tokyo (JP)

Correspondence Address: MOTS LAW, PLLC, 1629 K STREET N.W., SUITE 602, WASHINGTON, DC, 20006-1635, US

(73) Assignee: NTT DoCoMo, Inc., Tokyo (JP)

(21) Appl. No.: 12/390,647

(22) Filed: Feb. 23, 2009

(30) Foreign Application Priority Data
Feb. 25, 2008 (JP) P2008-043540
Apr. 21, 2008 (JP) P2008-110735

(51) Int. Cl. H04B 7/216

(52) U.S. Cl. 370/335

(57) ABSTRACT

A radio base station includes an assignment unit that selects a transmission rate control channel channelization code assigned to a fewest mobile stations, upon receipt of a communication start request from a mobile station, from among a plurality of transmission rate control channel channelization codes specified by a radio network controller and then assigns a selected transmission rate control channel channelization code to the mobile station.

### CROSS REFERENCE TO RELATED APPLICATION

This application is based upon and claims the benefit of priority from prior Japanese Patent Application No. 2008-043540, filed on Feb. 25, 2008 and Japanese Patent Application No. 2008110735, filed on Apr. 21, 2008; the entire contents of which are incorporated herein by reference.

### BACKGROUND OF THE INVENTION

1. Field of the Invention

The present invention relates to a mobile communication method, a mobile communication system, and a radio base station, in which a mobile station transmits uplink user data by using a transmission rate notified by a radio base station via a transmission rate control channel.

2. Description of the Related Art

In a mobile communication system adopting Enhanced Uplink (EUL)/High Speed Uplink Packet Access (HSUPA) defined in 3GPP, a mobile station UE is configured to transmit uplink user data by using a transmission rate notified by a radio base station NodeB via a transmission rate control channel (E-AGCH: E-DCH Absolute Grant Channel)(see 3GPP TS25.433 V6.15.0).

However, 3GPP does not define a method by which E-AGCH channelization code (hereinafter, referred to as E-AGCH CC) is assigned to the mobile station UE.

Accordingly, as shown in FIG. 1, when only a specific E-AGCH CC (in an example of FIG. 1, an E-AGCH CC#0) is assigned to a number of mobile stations UE (in an example of FIG. 1, mobile stations UE #1, #8, #4, #2, #5), there are problems that a radio base station NodeB is not capable of transmitting via an E-AGCH using the specific E-AGCH CC to a mobile station UE which desires the E-AGCH using the specific E-AGCH CC, and ununiformity occurs in transmission frequencies in each of the E-AGCHs.

### SUMMARY OF THE INVENTION

A first aspect of the present invention is summarized as a mobile communication method by which a mobile station transmits uplink user data by using a transmission rate notified by a radio base station via a transmission rate control channel. The mobile communication method includes: (A) causing a radio network controller to specify a plurality of transmission rate control channel channelization codes assignable to the mobile station, for the radio base station; (B) causing the radio base station to select a transmission rate control channel channelization code assigned to a fewest mobile stations, upon receipt of a communication start request from the mobile station, from among the plurality of transmission rate control channel channelization codes specified in the (A); (C) causing the radio base station to assign the transmission rate control channel channelization code selected in the (B) to the mobile station; and (D) causing the mobile station to transmit the uplink user data by using the transmission rate notified via the transmission rate control channel corresponding to the transmission rate control channel channelization code assigned in the (C).

A second aspect of the present invention is summarized as a mobile communication system in which a mobile station is configured to transmit uplink user data by using a transmission rate notified by a radio base station via a transmission rate control channel. The mobile communication system includes: a radio network controller configured to specify a plurality of transmission rate control channel channelization codes assignable to the mobile station, for the radio base station. The radio base station is configured to select a transmission rate control channel channelization code assigned to a fewest mobile stations, upon receipt of a communication start request from the mobile station, from among the plurality of transmission rate control channel channelization codes specified by the radio network controller, and then to assign a selected transmission rate control channel channelization code to the mobile station. The mobile station is configured to transmit the uplink user data by using the transmission rate notified via the transmission rate control channel corresponding to the selected transmission rate control channel channelization code assigned by the radio base station.

In the second aspect of the present invention, the radio base station is configured to select the transmission rate control channel channelization code assigned to the fewest mobile stations, from transmission rate control channel channelization codes corresponding to a group identifier of the mobile station, among the plurality of transmission rate control channel channelization codes specified by the radio network controller.

In the second aspect of the present invention, when a plurality of the transmission rate control channel channelization codes are selected, the radio base station assigns a transmission rate control channel channelization code having a smallest identification number in a plurality of selected transmission rate control channel channelization codes to the mobile station.

A third aspect of the present invention is summarized as a mobile communication method by which a mobile station transmits uplink user data by using a transmission rate notified by a radio base station via a transmission rate control channel. The mobile communication method includes: (A) causing a radio network controller to specify a plurality of transmission rate control channel channelization codes assignable to the mobile station, for the radio base station; (B) causing the radio base station to select a transmission rate control channel channelization code corresponding to the transmission rate control channel through which the transmission rate has been notified most frequently in a past predetermined period, upon receipt of a communication start request from the mobile station, from among the plurality of transmission rate control channel channelization codes specified in the A; (C) causing the radio base station to assign the transmission rate control channel channelization code selected in the B to the mobile station; and (D) causing the mobile station to transmit the uplink user data by using the transmission rate notified via the transmission rate control channel corresponding to the transmission rate control channel channelization code assigned in the C.

A fourth aspect of the present invention is summarized as a radio base station used in a mobile communication system in which a mobile station transmits uplink user data by using a transmission rate notified by the radio base station via a transmission rate control channel. The radio base station includes: an assignment unit configured to select a transmission rate control channel channelization code assigned to a fewest mobile stations, upon receipt of a communication start request from the mobile station, from among a plurality of transmission rate control channel channelization codes specified by a radio network controller, and then to assign a selected transmission rate control channel channelization code to the mobile station.

In the fourth aspect of the present invention, the assignment unit selects the transmission rate control channel channelization code assigned to the fewest mobile stations, from transmission rate control channel channelization codes corresponding to a group identifier of the mobile station, among the plurality of transmission rate control channel channelization codes specified by the radio network controller.

In the fourth aspect of the present invention, when a plurality of the transmission rate control channel channelization codes are selected, the assignment unit assigns a transmission rate control channel channelization code having a smallest identification number in a plurality of selected transmission rate control channel channelization codes, to the mobile station.

A fifth aspect of the present invention is summarized as a radio base station used in a mobile communication system in which a mobile station transmits uplink user data by using a transmission rate notified by the radio base station via a transmission rate control channel. The radio base station includes: an assignment unit configured to select a transmission rate control channel channelization code corresponding to the transmission rate control channel through which the transmission rate has been notified most frequently in a past predetermined period, upon receipt of a communication start request from the mobile station, from among a plurality of transmission rate control channel channelization codes specified by a radio network controller, and then to assign a selected transmission rate control channel channelization code to the mobile station.

In the first aspect of the present invention, in the B, the radio base station selects the transmission rate control channel channelization code assigned to the fewest mobile stations in a unit time, upon receipt of the communication start request from the mobile station, from among the plurality of transmission rate control channel channelization codes specified in the A.

In the second aspect of the present invention, the radio base station selects the transmission rate control channel channelization code assigned to the fewest mobile stations in a unit time, upon receipt of the communication start request from the mobile station, from among the plurality of transmission rate control channel channelization codes specified by the radio network controller, and then assigns the selected transmission rate control channel channelization code to the mobile station.

In the fourth aspect of the present invention, the assignment unit selects the transmission rate control channel channelization code assigned to the fewest mobile stations in a unit time, upon receipt of the communication start request from the mobile station, from among the plurality of transmission rate control channel channelization codes specified by the radio network controller, and then assigns the selected transmission rate control channel channelization code to the mobile station.

### BRIEF DESCRIPTION OF THE DRAWINGS

FIG. 1 is a view for explaining problems in a conventional mobile communication system.

FIG. 2 is an overall block diagram of a mobile communication system according to a first embodiment of the present invention.

FIG. 3 is a functional block diagram of a radio base station according to the first embodiment of the present invention.

FIG. 4 is a view for explaining an assignment method of an E-AGCH CC in the mobile communication system according to the first embodiment of the present invention.

FIG. 5 is a functional block diagram of a radio network controller according to the first embodiment of the present invention;

FIG. 6 is a flowchart showing overall operation of the mobile communication system according to the first embodiment of the present invention.

FIG. 7 is a flowchart showing operation in which a radio base station assigns an E-AGCH CC to a mobile station UE in the mobile communication system according to the first embodiment of the present invention.

FIG. 8 is a view for explaining an assignment method of an E-AGCH CC in a mobile communication system according to a second embodiment of the present invention.

FIG. 9 is a flowchart showing operation in which a radio base station assigns an E-AGCH CC to a mobile station UE in the mobile communication system according to the second embodiment of the present invention.

FIG. 10 is a view for explaining an assignment method of an E-AGCH CC in a mobile communication system according to a modification 1 of the present invention.

FIG. 11 is a view for explaining the assignment method of an E-AGCH CC in the mobile communication system according to the modification 1 of the present invention.

FIG. 12 is a flowchart showing operation in which a radio base station assigns an E-AGCH CC to a mobile station UE in the mobile communication system according to the modification 1 of the present invention.

FIG. 13 is a flowchart showing operation in which a radio base station assigns an E-AGCH CC to a mobile station UE in the mobile communication system of the modification 1 of the present invention.

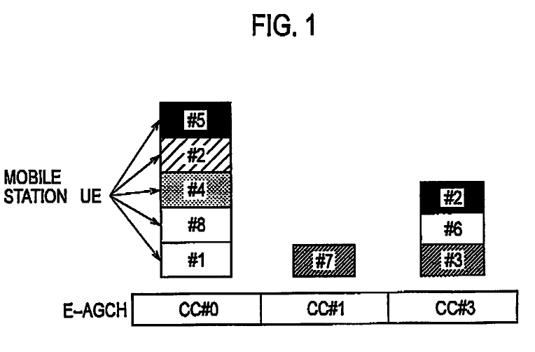

### DETAILED DESCRIPTION OF THE EMBODIMENTS

### Configuration of a Mobile Communication System According to a First Embodiment of the Present Invention

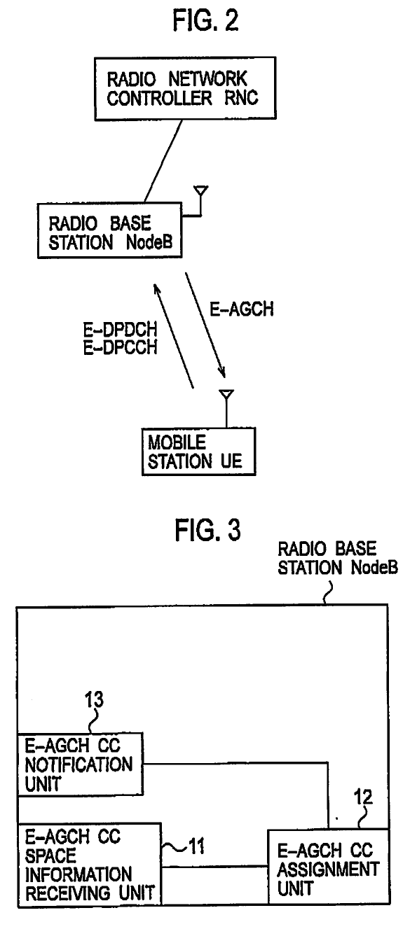

A configuration of a mobile communication system according to a first embodiment of the present invention is described with reference to FIGS. 2 to 5.

In the description of this embodiment an example is given of a mobile communication system adopting an EUL/HSUPA scheme defined in above-mentioned 3GPP. However, the present invention is not limited to the example.

As shown in FIG. 2, the mobile communication system according to this embodiment includes a radio network controller RNC, a radio base station NodeB, and a mobile station UE.

As shown in FIG. 3, the radio base station NodeB includes an E-AGCH CC space information receiving unit 11, an E-AGCH CC assignment unit 12, and an E-AGCH CC notification unit 13.

The E-AGCH CC space information receiving unit 11 is configured to receive E-AGCH CC space Information indicating a plurality of E-AGCH CCs specified by the radio network controller RNC.

Upon receipt of an EUL communication start request (a communication start request) from the mobile station UE, the E-AGCH CC assignment unit 12 is configured to select an E-AGCH CC assigned to a fewest mobile stations, from among a plurality of the E-AGCH CCs indicated in E-AGCH CC space information received by the E-AGCH CC space information receiving unit 11, and then to assign the thus selected E-AGCH CC to the mobile station UE.

When selecting a plurality of the E-AGCH CCs, the E-AGCH CC assignment unit 12 may be configured to assign an E-AGCH CC having the smallest identification number in the thus selected E-AGCH CCs, to the mobile station UE.

Further, the E-AGCH CC assignment unit 12 may also be configured to repeatedly assign the E-AGCH CCs in ascending order of the Identification number of the E-AGCH CCs to each mobile station UE transmitting the EUL communication start request.

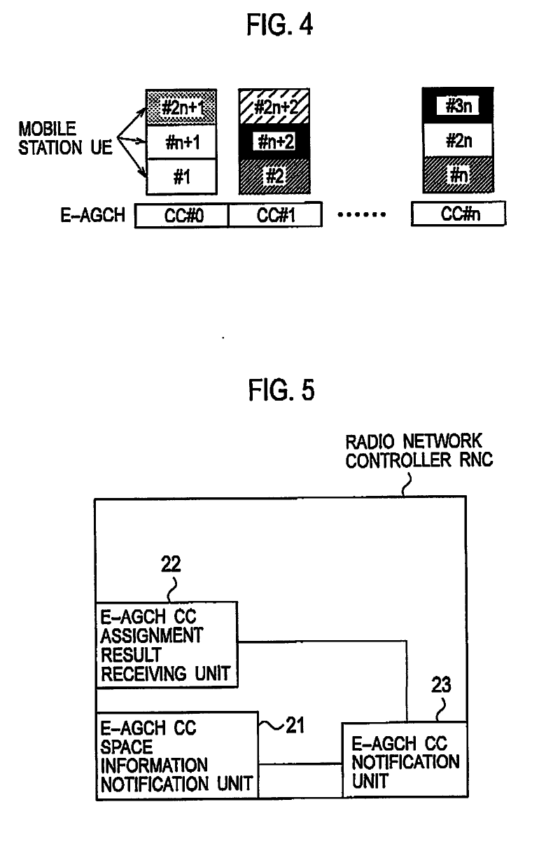

In an example of FIG. 4, the E-AGCH CC assignment unit 12 may be configured to assign the E-AGCH CCs to each one of mobile stations UE #1. #2, . . . , and #3n, transmitting an EUL communication start request, in the order of CC#0, CC#1, . . . →CC#n, CC#0, . . . .

As described above, the E-AGCH CC assignment unit 12 is configured to control the assignment of the plurality of E-AGCH CCs to mobile stations UE so that the number of mobile stations becomes uniform, to which each E-AGCH CC specified by the radio network controller RNC is assigned.

The E-AGCH CC notification unit 13 is configured to notify the radio network controller RNC of the E-AGCH CC assigned to the mobile station UE which has transmitted the EUL communication start request.

More specifically, the E-AGCH CC notification unit 13 is configured to notify the radio network controller RNC of the E-AGCH CC by using NBAP signaling and others.

As shown in FIG. 5, the radio network controller RNC includes an E-AGCH CC space information notification unit 21, an E-AGCH CC assignment result receiving unit 22, and an E-AGCH CC notification unit 23.

The E-AGCH CC space information notification unit 21 is configured to specify a plurality of E-AGCH CCs assignable to mobile stations UE, to the radio base station NodeB.

The E-AGCH CC assignment result receiving unit 22 is configured to receive, from the radio base station NodeB, a result of the assignment of the E-AGCH CC to the mobile station UE having transmitted the EUL communication start request.

The E-AGCH CC notification unit 23 is configured to notify the mobile station UE having transmitted the EUL communication start request of the E-AGCH CC assigned to the mobile station UE.

More specifically, the E-AGCH CC notification unit 23 is configured to notify the mobile station UE of the E-AGCH CC by using RRC signaling and others.

Further, the mobile station UE is configured to transmit uplink user data by using a transmission rate notified via the E-AGCH corresponding to the E-AGCH CC assigned (notified by the E-AGCH CC notification unit 23 of the radio network controller RNC) by the radio base station NodeB.

To be more specific, the mobile station UE is configured to manage an index identifying an AG, and a transport block by associating the index with the transport block, and to transmit uplink user data at a transport block size corresponding to an Absolute Grant (AG) notified via the E-AGCH.

Further, the mobile station UE is configured to manage an index identifying an AG and a transmission power ratio between an E-DCH Dedicated Physical Data Channel (E-DPDCH) and a Dedicated Physical Control Channel (DPCCH) by associating the index with the transmission power ratio, and to transmit uplink user data by use of the transmission power ratio corresponding to an AG notified via the E-AGCH.

### (Operation of the Mobile Communication System According to the First Embodiment of the Present Invention)

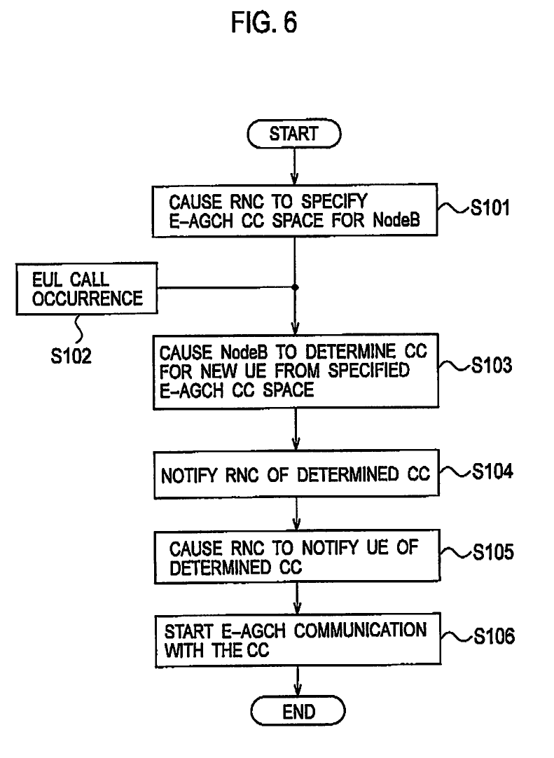

Operation of the mobile communication system according to this embodiment of the present invention is described with reference to FIGS. 6 and 6. First, overall operation of the mobile communication system according to this embodiment is described with reference to FIG. 6.

As shown in FIG. 6, in Step S101, the radio network controller RNC specifies a plurality of E-AGCH CCs (E-AGCH CC space) assignable to mobile stations UE, for the radio base station NodeB.

In Step S102, once a new mobile station UE transmits an EUL communication start request to the radio base station NodeB, the radio base station NodeB determines an E-AGCH CC to be assigned to the new mobile station UE from among the plurality of E-AGCH CCs (E-AGCH CC space) specified by the radio network controller RNC, in Step S103.

In Step S104, the radio base station NodeB notifies the radio network controller RNC of the E-AGCH CC assigned to the new mobile station UE.

In Step S105, the radio network controller RNC notifies the new mobile station UE of the E-AGCH CC.

In Step S106, the radio base station NodeB notifies the new mobile station UE of a transmission rate via an E-AGCH corresponding to the E-AGCH CC, and the new mobile station UE transmits uplink user data at the transmission rate.

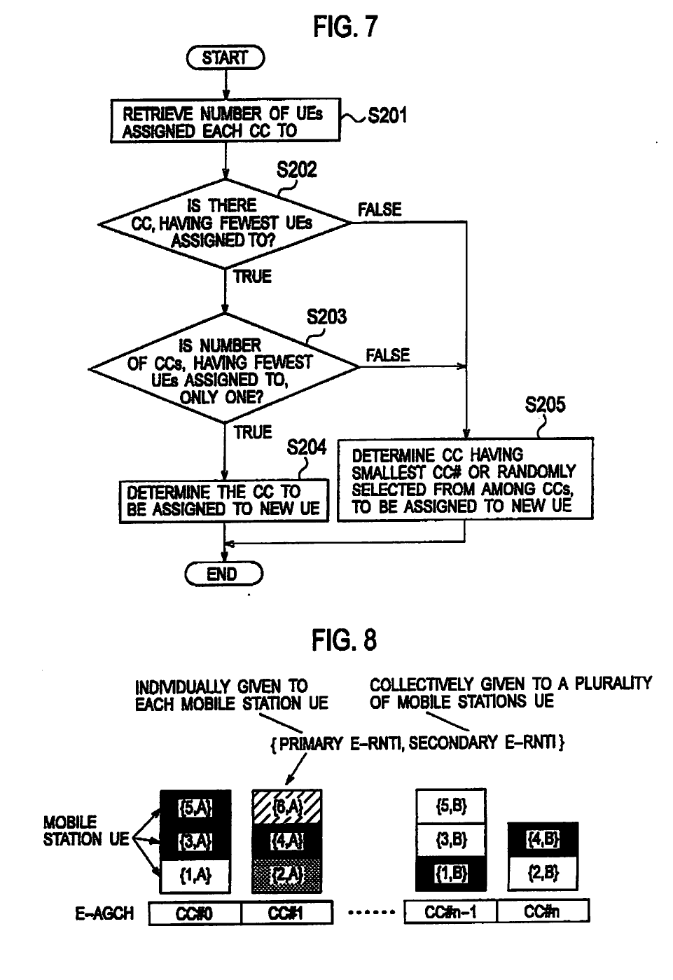

Here, with reference to FIG. 7, description is given of a method of determining an E-AGCH CC to be assigned to the new mobile station UE in Step S103.

As shown in FIG. 7, in Step S201, the radio base station NodeB retrieves the number of mobile stations UE to which each of a plurality of E-AGCH CCs specified by the radio network controller RNC is assigned.

In Step S202, the radio base station NodeB determines whether or not an E-AGCH CC assigned to a fewest mobile stations is present.

When it is determined that the E-AGCH CC is present, the radio base station NodeB determines whether or not the number of such E-AGCH CCs is one, in Step S203.

When it is determined that the number of such E-AGCH CCs is one, the radio base station NodeB determines the E-AGCH CC as an E-AGCH CC to be assigned to the new mobile station UE, in Step 8204.

Meanwhile, in Step S202, when it is determined that the E-AGCH CC assigned to the fewest mobile stations is not present, in Step S205, the radio base station NodeB determines, an E-AGCH CC having the smallest identification number, or an E-AGCH CC randomly selected as an E-AGCH CC to be assigned to the new mobile station UE, from among the plurality of E-AGCH CCs specified by the radio network controller RNC.

Further, in Step S203, when it is determined that the number of the E-AGCH CCs is not one, in Step S205, the radio base station NodeB determines an E-AGCH CC having the smallest identification number, or an E-AGCH CC randomly selected as an E-AGCH CC to be assigned to the new mobile station UE, from among the E-AGCH CCs assigned to the fewest mobile stations.

### (Operations and Effects of the Mobile Communication System According to the First Embodiment of the Present Invention)

In the mobile communication system according to this embodiment, the system is configured to assign an E-AGCH CC assigned to a fewest mobile stations, to a new mobile station UE. Accordingly, E-AGCH CCs can be uniformly assigned to a plurality of mobile stations UE. This can solve such problems that a radio base station NodeB is not capable of transmitting via an E-AGCH using the specific E-AGCH CC to a mobile station UE which desires the E-AGCH using the specific E-AGCH CC, and ununiformity occurs in transmission frequencies in each of the E-AGCHs to the mobile stations UE.

### (A Mobile Communication System According to a Second Embodiment of the Present Invention)

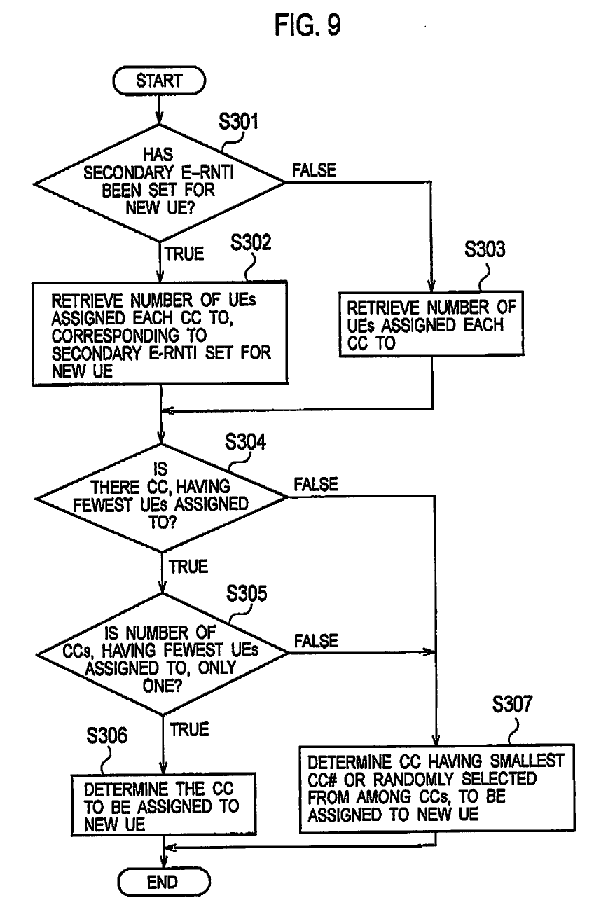

A mobile communication system according to a second embodiment of the present invention is described with reference to FIGS. 8 and 9. Description is given of the mobile communication system according to this embodiment focused on the difference from the mobile communication system according to the first embodiment.

In the mobile communication system according to this embodiment upon receipt of an EUL communication start request from a mobile station UE, the E-AGCH CC assignment unit 12 of the radio base station NodeB is configured to firstly select E-AGCH CCs corresponding to a group identifier (E-DCH radio network temporary identity: E-RNTI) of the mobile station UE from among a plurality of E-AGCH CCs specified by the radio network controller RNC and then to narrow down the selected E-AGCH CCs to an E-AGCH CC assigned to a fewest mobile stations.

As shown in FIG. 8, in the mobile communication system according to this embodiment, Primary E-RNTI is used as an individual identifier set for each mobile station UE, and Secondary E-RNTI is used as a group identifier set for each group including a plurality of mobile stations UE.

In an example of FIG. 8, E-AGCH CCs corresponding to Secondary E-RNTI #A are E-AGCH CC#0 and E-AGCH CC#1, and those corresponding to Secondary E-RNTI #B are E-AGCH CC#n−1 and E-AGCH CC#n.

Note that the E-AGCH CC assignment unit 12 is configured to manage a correspondence relationship between the E-AGCH CCs and Secondary E-RNTI.

Accordingly, upon receipt of an EUL communication start request from a mobile station UE for which Secondary E-RNTI #A is set, the E-AGCH CC assignment unit 12 is configured to select an E-AGCH CC assigned to a fewest mobile stations from the E-AGCH CC#0 and E-AGCH CC#1, as an E-AGCH CC to be assigned to the mobile station UE.

Further, upon receipt of an EUL communication start request from a mobile station UE in which Secondary E-RNTI #B is set, the E-AGCH CC assignment unit 12 is configured to select an E-AGCH CC assigned to the fewest mobile stations from the E-AGCH CC#n−1 and E-AGCH CC#n, as an E-AGCH CC to be assigned to the mobile station UE.

Operation of the mobile communication system according to this embodiment is described below. Since the overall operation of the mobile communication system according to this embodiment is the same as that of the first embodiment shown in FIG. 6, a method of determining an E-AGCH CC to be assigned to the new mobile station UE in Step S103 of FIG. 6 is described with reference to FIG. 6.

As shown in FIG. 9, in Step S301, upon receipt of an EUL communication start request from a new mobile station UE, the radio base station NodeB determines whether or not Secondary E-RNTI is set for the new mobile station UE.

When it is determined that Secondary E-RNTI is set for the new mobile station UE, the radio base station NodeB extracts E-AGCH CCs corresponding to the Secondary E-RNTI set for the new mobile station UE, from among a plurality of E-AGCH CCs specified by the radio network controller RNC, and then retrieves the number of mobile stations UE to which each of the thus extracted E-AGCH CCs is assigned, in Step S302. In subsequent steps in FIG. 9, non-extracted E-AGCH CCs are exempt from the assignment to the new mobile station UE.

Meanwhile, when it is determined that Secondary E-RNTI is not set for the new mobile station UE, the radio base station NodeB retrieves the number of mobile stations UE to which each of the plurality of E-AGCH CCs specified by the radio network controller RNC is assigned, in Step S303.

In Step S304, the radio base station NodeB determines whether or not an E-AGCH CC assigned to a fewest mobile stations is present.

When it is determined that the E-AGCH CC is present the radio base station NodeB determines whether or not the number of such E-AGCH CCs is one, in Step S305.

When it is determined that the number of such E-AGCH CCs is one, the radio base station NodeB determines the E-AGCH CC as an E-AGCH CC assigned to the new mobile station UE, in Step S306.

Meanwhile, in Step S304, when it is determined that the E-AGCH CC assigned to a fewest mobile stations is not present in Step S307, the radio base station Nodes determines, an E-AGCH CC having the smallest identification number, or an E-AGCH CC randomly selected as the E-AGCH CC to be assigned to the new mobile station UE, from among the plurality of E-AGCH CCs specified by the radio network controller RNC.

Further, in Step S305, when it is determined that the number of the E-AGCH CCs is not one, in Step S307, the radio base station NodeB determines an E-AGCH CC having the smallest identification number, or an E-AGCH CC randomly selected as an E-AGCH CC to be assigned to the new mobile station UE, from among the E-AGCH CCs assigned to a fewest mobile stations.

In the mobile communication system of this embodiment, the system is configured to select an E-AGCH CC assigned to a fewest mobile stations from among a plurality of E-AGCH CCs corresponding to an Secondary E-RNTI set for a new mobile station UE, and to assign the selected E-AGCH CC to the new mobile station UE. Accordingly, E-AGCH CCs can be uniformly assigned to a plurality of mobile stations UE belonging to the same Secondary E-RNTI. This can solve such problems that a radio base station NodeB is not capable of transmitting via an E-AGCH using the specific E-AGCH CC corresponding to the Secondary E-RNTI to a mobile station UE which desires the E-AGCH using the specific E-AGCH CC corresponding to the Secondary E-RNTI, and ununiformity occurs in transmission frequencies in each of the E-AGCHs to the mobile stations UE, and ununiformity occurs in transmission frequencies in each of the E-AGCHs to the mobile stations UE.

### (A Mobile Communication System According to a Third Embodiment of the Present Invention)

Description is given of a mobile communication system according to a third embodiment of the present invention, focused on the difference from the mobile communication system of the aforementioned first and second embodiments.

In this embodiment, upon receipt of an EUL communication start request from a mobile station UE, the E-AGCH CC assignment unit 12 of the radio base station NodeB is configured to select an E-AGCH CC (a transmission rate control channel channelization code) corresponding to an E-AGCH (transmission rate control channel) through which an AG (transmission rate) other than “Zero Grant” has been notified most frequently in a past predetermined period, from among a plurality of E-AGCH CCs (a plurality of transmission rate control channel channelization codes) specified by the radio network controller RNC.

For example, assume a case where in the past predetermined period, in an E-AGCH#1 corresponding to an E-AGCH CC#1, most of the time, “Zero Grant” has been notified, while in an E-AGCH#2 corresponding to an E-AGCH CC#2, most of the time, AGs other than “Zero Grant” have been notified. For this case, the E-AGCH CC assignment unit 12 is configured to select the E-AGCH CC#2.

Further, in a flowchart of FIG. 7, instead of the operation in Step S205, the E-AGCH CC assignment unit 12 may be configured to perform an operation of selecting an E-AGCH CC corresponding to an E-AGCH through which an AG other than “Zero Grant” has been notified most frequently in a past predetermined period from among a plurality of E-AGCH CCs specified by the radio network controller RNC.

Specifically, upon receipt of an EUL communication start request from the mobile station UE, the E-AGCH CC assignment unit 12 may be configured to perform the following operation. The E-AGCH CC assignment unit 12 selects an E-AGCH CC assigned to a fewest mobile stations from among the plurality of E-AGCH CCs specified by the radio network controller RNC. When selecting a plurality of E-AGCH CCs in this case, the E-AGCH CC assignment unit 12 selects an E-AGCH CC corresponding to an E-AGCH through which an AG other than “Zero Grant” has been notified most frequently in a past predetermined period, from among the thus selected E-AGCH CCs.

Further, in a flowchart of FIG. 9, the E-AGCH CC assignment unit 12 may be configured, Instead of an operation of Step S307, to perform an operation of selecting an E-AGCH CC corresponding to an E-AGCH through which an AG other than “Zero Grant” has been notified most frequently in a past predetermined period, from among a plurality of E-AGCH CCs specified by the radio network controller RNC,

Specifically, from among the plurality of E-AGCH CCs specified by the radio network controller RNC, the E-AGCH CC assignment unit 12 may be configured to perform an operation of selecting E-AGCH CCs corresponding to a group Identifier (E-DCH radio network temporary identity: E-RNTI) of the mobile station UE, and then narrowing down the selected E-AGCH CCs to an E-AGCH CC corresponding to an E-AGCH through an AG other than “Zero Grant” has been notified most frequently in a past predetermined period.

### Modification 1 of the Present Invention

Description is given of a mobile communication system according to a modification 1 of the present invention, focused on the difference from the mobile communication system of the aforementioned first and second embodiments.

In this modification 1, upon receipt of an EUL communication start request from a mobile station UE, the E-AGCH CC assignment unit 12 of the radio base station NodeB is configured to select an E-AGCH CC assigned to a fewest mobile stations in a unit time, from among a plurality of E-AGCH CCs (a plurality of transmission rate control channel channelization codes) specified by the radio network controller RNC.

In a mobile communication system to which an EUL scheme is applied, two types of Transmission Time Intervals (TTIs), that is, 2 ms and 10 ms, are applicable.

When a TTI of 2 ms and a Tri of 10 ms mixedly exist, as in the mobile communication systems of the first and second embodiments, the E-AGCH CC assignment unit 12 of the radio base station NodeB is configured to select an E-AGCH CC assigned to a fewest mobile stations without considering the TTI length, from among the plurality of E-AGCH CCs specified by the radio network controller RNC, and thereby to distribute the mobile stations UE to each of the E-AGCH CCs uniformly.

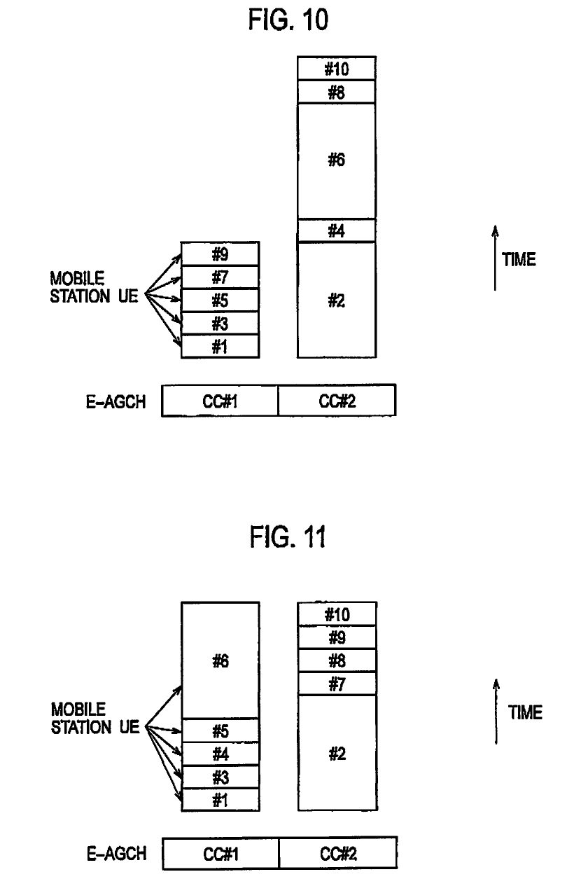

In this case, since occupancy time of an E-AGCH CC by a call having a TTI of 10 ms is five times longer than that of an E-AGCH CC by a call having a TTI of 2 ms, ununiformity might occur in a transmission frequency in the E-AGCH corresponding to each E-AGCH CC, as shown in FIG. 10.

Accordingly, upon receipt of the EUL communication start request from the mobile station UE, the E-AGCH CC assignment unit 12 of the radio base station NodeB is configured to select an E-AGCH CC assigned to a fewest mobile stations in a unit time, from among the plurality of E-AGCH CCs specified by the radio network controller RNC, as shown in FIG. 11.

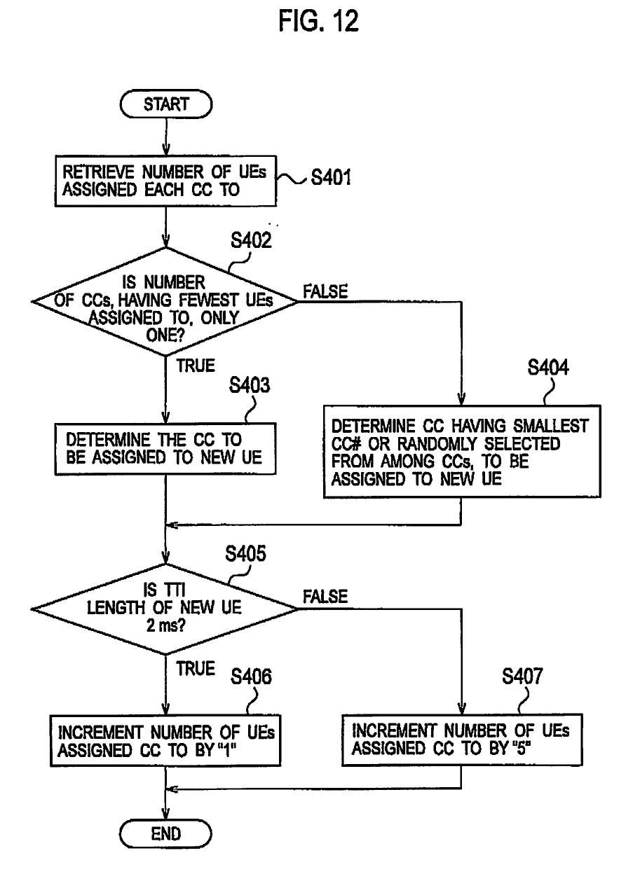

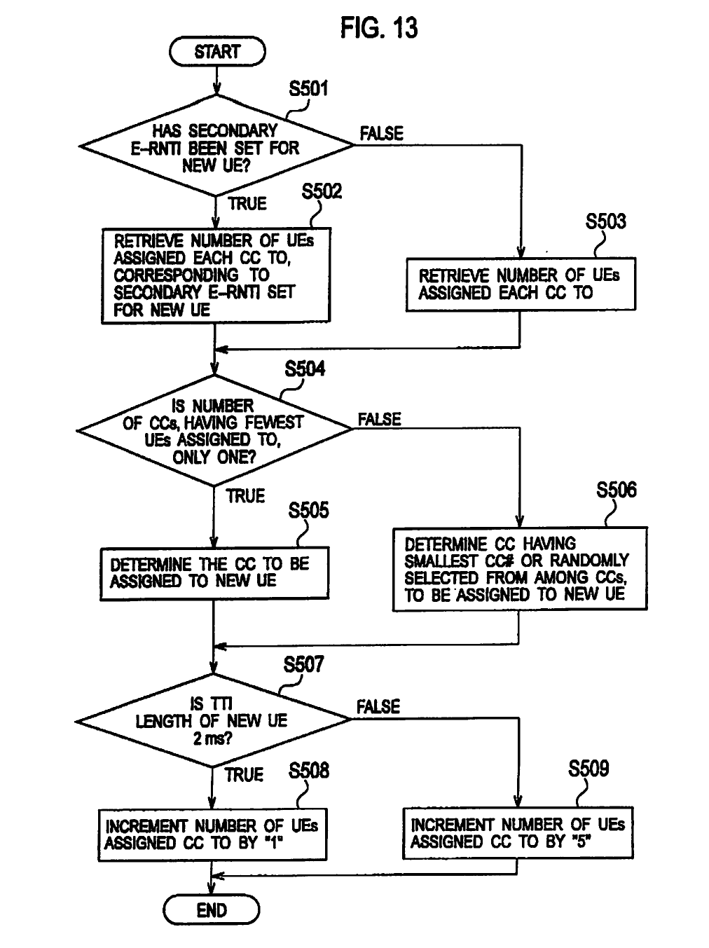

Operation of the mobile communication system according to this modification 1 is described below with reference to FIGS. 12 and 13. The overall operation of this modification 1 is the same as that of the first embodiment shown in FIG. 6.

First, with reference to FIG. 12, description is given of a method of determining an E-AGCH CC to be assigned to the new mobile station UE in Step S1 03 of FIG. 6 (corresponding to the first embodiment).

As shown in FIG. 12, in Step S401, the radio base station NodeB retrieves the number of mobile stations UE to which each one of a plurality of E-AGCH CCs specified by the radio network controller RNC is assigned.

In Step S402, the radio base station NodeB determines whether or not the number of E-AGCH CCs assigned to a fewest mobile stations is only one.

When it is determined that the number of such E-AGCH CCs is only one, the radio base station NodeB determines the E-AGCH CC, in Step S403, as an E-AGCH CC to be assigned to the new mobile station UE.

Meanwhile, in Step S402, when it is determined that the number of the E-AGCH CCs is not one, in Step S404, the radio base station NodeB determines an E-AGCH CC having the smallest identification number, or an E-AGCH CC randomly selected as an E-AGCH CC to be assigned to the new mobile station UE, from among the plurality of E-AGCH CCs specified by the radio network controller RNC or from among the E-AGCH CCs assigned to the fewest mobile stations.

In Step S405, the radio base station NodeB determines whether or not a TTI applied to the new mobile station UE is 2 ms.

When it is determined that the TTI is 2 ms, in Step S406, the number of UEs assigned the E-AGCH CC selected in Step S403 or Step S404 is Incremented by “1”.

By contrast, when it is determined that the TTI is not 2 ms (that is, 10 ms), the number of UEs assigned the E-AGCH CC selected in Step S403 or Step S404 is incremented by “5” in Step S407 (that is, a quotient obtained by dividing a TTI (10 ms) applied to the new mobile station UE by a reference TTI (2 ms)).

Second, with reference to FIG. 13, description is given of a method of determining an E-AGCH CC to be assigned to the new mobile station UE in Step S103 of FIG. 6 (corresponding to the second embodiment).

As shown in FIG. 13, upon receipt of an EUL communication start request from a new mobile station UE, the radio base station NodeB determines whether or not a Secondary E-RNTI has been set for the new mobile station UE, in Step S501.

When it is determined that Secondary E-RNTI has been set for the new mobile station UE, the radio base station NodeB extracts E-AGCH CCs corresponding to the Secondary E-RNTI set for the new mobile station UE, from among the plurality of E-AGCH CCs specified by the radio network controller RNC, and then retrieves the number of mobile stations UE to each one of the thus extracted E-AGCH CCs is assigned, in Step S502. In subsequent steps in FIG. 13, non-extracted E-AGCH CCs are exempt from the assignment to the new mobile station UE.

By contrast, when it is determined that Secondary E-RNTI has not been set for the new mobile station UE, the radio base station NodeB retrieves the number of mobile stations UE assigned to each one of the plurality of E-AGCH CCs specified by the radio network controller RNC, in Step S503.

In Step S504, the radio base station NodeB determines whether or not the number of E-AGCH CCs assigned to the fewest mobile stations is only one.

When it is determined that the number of such E-AGCH CCs is only one, the radio base station NodeB determines the E-AGCH CC as an E-AGCH CC to be assigned to the new mobile station UE, in Step S505.

Meanwhile, in Step S504, when it is determined that the number of the E-AGCH CCs is not one, in Step S506, the radio base station NodeB determines an E-AGCH CC having the smallest identification number or an E-AGCH CC randomly selected as an E-AGCH CC to be assigned to the new mobile station UE, from among the plurality of E-AGCH CCs specified by the radio network controller RNC or from among the E-AGCH CCs assigned to a fewest mobile stations.

In Step S507, the radio base station NodeB determines whether or not a TTI applied to the new mobile station UE is 2 ms.

When it is determined that the TTI is 2 ms, the number of UEs assigned the E-AGCH CC selected in Step S505 or Step S506 is incremented by “1,” in Step S508

By contrast, when it is determined that the TTI is not 2 ms (that is, 10 ms), the number of UEs assigned the E-AGCH CC selected in Step S505 or Step S506 is incremented by “5” in Step S509 (that is, a quotient obtained by dividing a TTI (10 ms) applied to the new mobile station UE by a reference TTI (2 ms)).

According to the mobile communication system of this modification 1, even when mobile station UEs by using different TTIs mixedly exist, it is possible to reduce ununiformity in a transmission frequency in the E-AGCH corresponding to each E-AGCH CC, so that an effective use of code resource can be achieved.

Note that the performances of the above-mentioned mobile station UE, the radio base station NodeB and the radio network controller RNC may be implemented by hardware, by a software module executed by a processor, or by a combination of the two.

The software module may be provided in a storage medium of any form such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, and a CD-ROM.

The storage medium is connected to a processor so that the processor can read and write Information from and to the storage medium. The storage medium may otherwise be integrated in a processor. The storage medium and the processor may be provided within an ASIC, and the ASIC may be provided in a mobile station UE, a radio base station NodeB and a radio network controller RNC. Otherwise, the storage medium and the processor may be provided in each of a mobile station UE, a radio base station NodeB and a radio network controller RNC as discrete components.

Hereinabove, the present invention has been described in detail by use of the embodiment. However, it is obvious to those skilled in the art that the present invention is not limited to the embodiment described herein. The present invention may be implemented as a modification and a variation, within the spirit and scope of the present invention defined by the scope of claims. Accordingly, the present specification aims to provide an exemplary description and does not limit the present invention in any way.

What is claimed is:

1. A mobile communication method by which a mobile station transmits uplink user data by using a transmission rate notified by a radio base station via a transmission rate control channel, the method comprising:
(A) causing a radio network controller to specify a plurality of transmission rate control channel channelization codes assignable to the mobile station, for the radio base station;
(B) causing the radio base station to select a transmission rate control channel channelization code assigned to a fewest mobile stations, upon receipt of a communication start request from the mobile station, from among the plurality of transmission rate control channel channelization codes specified in the (A);
(C) causing the radio base station to assign the transmission rate control channel channelization code selected in the (B) to the mobile station; and
(D) causing the mobile station to transmit the uplink user data by using the transmission rate notified via the transmission rate control channel corresponding to the transmission rate control channel channelization code assigned in the (C).

2. A mobile communication system in which a mobile station is configured to transmit uplink user data by using a transmission rate notified by a radio base station via a transmission rate control channel, the system comprising:
a radio network controller configured to specify a plurality of transmission rate control channel channelization codes assignable to the mobile station, for the radio base station, wherein
the radio base station is configured to select a transmission rate control channel channelization code assigned to a fewest mobile stations, upon receipt of a communication start request from the mobile station, from among the plurality of transmission rate control channel channelization codes specified by the radio network controller, and then to assign a selected transmission rate control channel channelization code to the mobile station, and
the mobile station is configured to transmit the uplink user data by using the transmission rate notified via the transmission rate control channel corresponding to the selected transmission rate control channel channelization code assigned by the radio base station.

3. The mobile communication system according to claim 2, wherein the radio base station is configured to select the transmission rate control channel channelization code assigned to the fewest mobile stations, from transmission rate control channel channelization codes corresponding to a group identifier of the mobile station, among the plurality of transmission rate control channel channelization codes specified by the radio network controller.

4. The mobile communication system according to claim 2, wherein when a plurality of the transmission rate control channel channelization codes are selected, the radio base station assigns a transmission rate control channel channelization code having a smallest identification number in a plurality of selected transmission rate control channel channelization codes to the mobile station.

5. A mobile communication method by which a mobile station transmits uplink user data by using a transmission rate notified by a radio base station via a transmission rate control channel, the method comprising:
(A) causing a radio network controller to specify a plurality of transmission rate control channel channelization codes assignable to the mobile station, for the radio base station;
(B) causing the radio base station to select a transmission rate control channel channelization code corresponding to the transmission rate control channel through which the transmission rate has been notified most frequently in a past predetermined period, upon receipt of a communication start request from the mobile station, from among the plurality of transmission rate control channel channelization codes specified in the A;
(C) causing the radio base station to assign the transmission rate control channel channelization code selected in the B to the mobile station; and
(D) causing the mobile station to transmit the uplink user data by using the transmission rate notified via the transmission rate control channel corresponding to the transmission rate control channel channelization code assigned in the C.

6. A radio base station used in a mobile communication system in which a mobile station transmits uplink user data by using a transmission rate notified by the radio base station via a transmission rate control channel, the radio base station comprising:
an assignment unit configured to select a transmission rate control channel channelization code assigned to a fewest mobile stations, upon receipt of a communication start request from the mobile station, from among a plurality of transmission rate control channel channelization codes specified by a radio network controller, and then to assign a selected transmission rate control channel channelization code to the mobile station.

7. The radio base station according to claim 6, wherein the assignment unit selects the transmission rate control channel channelization code assigned to the fewest mobile stations, from transmission rate control channel channelization codes corresponding to a group identifier of the mobile station, among the plurality of transmission rate control channel channelization codes specified by the radio network controller.

8. The radio base station according to claim 6, wherein when a plurality of the transmission rate control channel channelization codes are selected, the assignment unit assigns a transmission rate control channel channelization code having a smallest identification number in a plurality of selected transmission rate control channel channelization codes, to the mobile station.

9. A radio base station used in a mobile communication system in which a mobile station transmits uplink user data by using a transmission rate notified by the radio base station via a transmission rate control channel, the radio base station comprising:
an assignment unit configured to select a transmission rate control channel channelization code corresponding to the transmission rate control channel through which the transmission rate has been notified most frequently in a past predetermined period, upon receipt of a communication start request from the mobile station, from among a plurality of transmission rate control channel channelization codes specified by a radio network controller, and then to assign a selected transmission rate control channel channelization code to the mobile station.

10. The mobile communication method according to claim 1, wherein in the B, the radio base station selects the transmission rate control channel channelization code assigned to the fewest mobile stations in a unit time, upon receipt of the communication start request from the mobile station, from among the plurality of transmission rate control channel channelization codes specified in the A.

11. The mobile communication system according to claim 2, wherein the radio base station selects the transmission rate control channel channelization code assigned to the fewest mobile stations in a unit time, upon receipt of the communication start request from the mobile station, from among the plurality of transmission rate control channel channelization codes specified by the radio network controller, and then assigns the selected transmission rate control channel channelization code to the mobile station.

12. The radio base station according claim 6, wherein the assignment unit selects the transmission rate control channel channelization code assigned to the fewest mobile stations in a unit time, upon receipt of the communication start request from the mobile station, from among the plurality of transmission rate control channel channelization codes specified by the radio network controller, and then assigns the selected transmission rate control channel channelization code to the mobile station.
